(19) United States
(12) Patent Application Publication
(10) Pub. No.: US 2026/0244542 A1
(43) Pub. Date: Aug. 20, 2026

(54) PORT-BINDING DISASTER RECOVERY METHOD AND APPARATUS FOR STORAGE SYSTEM, AND DEVICE AND NON-VOLATILE READABLE STORAGE MEDIUM

(71) Applicant: SUZHOU METABRAIN INTELLIGENT TECHNOLOGY CO., LTD., Suzhou, Jiangsu (CN)

(72) Inventors: Yankai ZHANG, Suzhou, Jiangsu (CN); Ximeng ZHOU, Suzhou, Jiangsu (CN)

(21) Appl. No.: 19/162,466

(22) PCT Filed: Sep. 29, 2024
(86) PCT No.: PCT/CN2024/122463

§ 371 Date: Sep. 5, 2025

(30) Foreign Application Priority Data
Dec. 28, 2023 (CN) 202311829151.3

(51) Int. Cl. G06F 11/20

(52) U.S. Cl. CPC G06F 11/201

(57) ABSTRACT

Provided in the present application are a port-binding disaster recovery method and apparatus for a storage system, and a device and a non-volatile readable storage medium. The method comprises: respectively binding ports of a first device and ports of a second device, so as to form several communication paths, and calculating the performance of each communication path; grouping the communication paths on the basis of the performance of the communication paths, and performing data transmission on the basis of groups; and in response to an abnormality occurring in communication paths, adjusting the groups of the communication paths on the basis of the cause of the abnormality and the number of communication paths in each group. By means of the solution of the present application, the stability and disaster recovery capability of communication services can be improved in a scenario where a plurality of paths have faults; an enabled path can be switched and used to share service pressure in a scenario where links are congested and the performance pressure is large, and the storage performance can be improved at a port level, so as to ensure the smoothness and stability of client services; and the stable switching of a communication path can be realized, and risk early warning can be performed, so as to reduce the risk of a path having a fault or being missing.

### CROSS-REFERENCE TO RELATED DISCLOSURE

The present disclosure claims priority to the Chinese patent disclosure No. 202311829151.3, entitled “PORT-BINDING DISASTER RECOVERY METHOD AND APPARATUS FOR STORAGE SYSTEM, AND DEVICE AND NON-VOLATILE READABLE STORAGE MEDIUM” filed on Dec. 28, 2023 before the China National Intellectual Property Administration, the entire contents of which are incorporated herein by reference.

### TECHNICAL FIELD

The present disclosure relates to the field of computers, and more particularly, to a method, a device, equipment and a non-volatile readable storage medium for storage system port binding disaster recovery.

### BACKGROUND

The SAN (Storage Area Network) network based on RoCE (RDMA over Converged Ethernet, where RDMA (Remote Direct Memory Access) can transfer data from one server to another server, or from a storage to a server, with very little occupation of CPU) in a storage system has become the trend of the times. In a RoCE-SAN network, there is a need to ensure connectivity from the storage-side network port to the server-side network port. Once a link problem occurs, the network link connection between the storage and the server will inevitably fail. Since the links of the RoCE-SAN are independent of each other, mutual redundancy to improve the stability of customer business cannot be achieved, and business equilibrium cannot be achieved, which will result in uneven distribution of network resources and single-link congestion scenarios, affecting the business performance and customer experience. In the case of link failure, the stability of the customer business is directly threatened.

ROCE multi-control (interconnection) storage is a kind of comprehensive storage system that realizes the network intercommunication between multi-state storage through ROCE networking, and builds storage clusters. The storage of ROCE multi-control storage and the cluster path between the storage are also mutually independent. There is also an unbalanced business, a single-path congestion scenario will occur, and the lease overdue problem tends to occur, which greatly limits the upper limit of disaster recovery capability of multi-control storage and further limits the stability of the storage system.

### SUMMARY

In view of this, the purpose of the embodiments of the present disclosure is to provide a method, a device, equipment and a non-volatile readable storage medium for storage system port binding disaster recovery. By using the technical solution of the invention, the stability and disaster recovery capability of a communication business can be improved under the scene that multiple paths fail, the standby path can be switched and used to share the business pressure under the scene that the link congestion performance pressure is large, the storage performance can be improved at the port level, and the smoothness and stability of a customer business can be ensured. According to the invention, stable switching of communication paths can be realized, risk forecast reminding is carried out, and the risk of path faults or missing is reduced.

Based on the objective above, an aspect of the present application discloses a method for storage system port binding disaster recovery, comprising:
respectively binding a port of a first device and a port of a second device to form a plurality of communication paths, and calculating a performance of each communication path;
dividing the communication paths into groups based on the performance of the communication paths and performing data transmission based on the groups; and
in response to an abnormality in the communication path, adjusting a group-dividing way of the communication paths based on the abnormality cause and a quantity of communication paths in the groups.

According to an embodiment of the present disclosure, the step of dividing the communication paths into groups based on the performance of the communication paths and performing data transmission based on the groups comprises:
ranking the performances of communication paths from high to low;
selecting a threshold quantity of communication paths with a preceding performance ranking as members of an available group for data transmission; and
taking remaining communication paths as members of a backup group.

According to an embodiment of the present disclosure, selecting a threshold quantity of communication paths with a preceding performance ranking as members of an available group for data transmission comprises:
determining the communication paths with a first 50% of the performance ranking as members of the available group;
taking remaining communication paths as members of a backup group comprises:
determining the communication paths with a last 50% of the performance ranking as members of the backup group.

According to an embodiment of the present disclosure, determining the communication paths with a first 50% of the performance ranking as members of the available group comprises:
setting the communication paths with the first 50% of the performance ranking as members of an active state, wherein the communication paths in the active state are used for data transmission;
and determining the communication paths with a last 50% of the performance ranking as members of the backup group comprises:
setting the communication paths with the last 50% of the performance ranking to an enabled state, wherein the communication paths in the enabled state are used for taking over abnormal communication paths in the available group for data transmission when an abnormity occurs to the communication paths in the available group.

According to an embodiment of the present disclosure, the step of in response to an abnormality in the communication path, adjusting a group-dividing way of the communication paths based on the abnormality cause and a quantity of communication paths in the groups comprises:
determining the abnormity cause of the communication path in response to an occurrence of an abnormity of the communication path;
executing a first preset strategy in response to the abnormity cause of the communication path being a path disconnection; and
executing a second preset strategy in response to the abnormity cause of the communication path being path congestion.

According to an embodiment of the present disclosure, the step of executing a first preset strategy in response to the abnormity cause of the communication path being a path disconnection comprises:
in response to the abnormity cause of the communication path being path disconnection, marking a disconnected communication path as an unavailable path, and determining a group-dividing way of the disconnected communication path;
in response to the disconnected communication path being grouped into the backup group, acquiring the quantity of communication paths of the backup group, and performing a first preset operation based on an acquired quantity; and
in response to the disconnected communication path being grouped into the available group, acquiring the quantity of communication paths of the backup group, and performing a second preset operation based on an acquired quantity.

According to an embodiment of the present disclosure, the step of in response to the disconnected communication path being grouped into the backup group, acquiring the quantity of communication paths of the backup group, and performing a first preset operation based on the acquired quantity comprises:
acquiring the quantity of communication paths of the backup group in response to the disconnected communication path being grouped into the backup group;
in response to the quantity of communication paths of the backup group being less than 1, sending a warning of no redundant path; and
in response to the quantity of communication paths of the backup group being equal to 1, clearing the warning of no redundant path, and sending a warning of insufficient redundant paths.

According to an embodiment of the present disclosure, the step of in response to the disconnected communication path being grouped into the available group, acquiring the quantity of communication paths of the backup group, and performing a second preset operation based on an acquired quantity comprises:
acquiring the quantity of communication paths of the backup group in response to the disconnected communication path being grouped into the available group;
in response to the quantity of communication paths of the backup group being equal to 1, switching the communication paths of the backup group to the available group and setting the same to active state and sending a warning of no redundant path;
in response to the quantity of communication paths of the backup group being greater than 1, calculating performances of all the communication paths in the backup group;
switching communication path with a highest performance to the available group and setting the same to the active state; and
in response to the quantity of communication paths of the backup group being less than 1, sending a warning of no redundant path.

According to an embodiment of the present disclosure, the step of executing a second preset strategy in response to the abnormity cause of the communication path being path congestion comprises:
in response to the abnormity cause of the communication path being path congestion, calculating the performances of the communication path in which congestion occurs and all communication paths in the backup group;
in response to the communication path with a highest performance being a communication path where congestion occurs, taking no action; and
in response to the communication path with the highest performance being a communication path in the backup group, switching the communication path with the highest performance in the backup group to the available group and setting the same to the active state.

According to an embodiment of the present disclosure, the step of binding a port of a first device and a port of a second device to form a communication path comprises:
binding a RoCE port of the first device with a RoCE port of the second device to form a communication path;
respectively creating a virtual network interface card of the RoCE port of the first device and a virtual network interface card of the RoCE port of the second device; and determining whether the first device is capable of communicating with the second device.

According to an embodiment of the present disclosure, the step of binding a RoCE port of the first device with a RoCE port of the second device to form a communication path comprises:
creating a one-to-one connection between each RoCE port of the first device and each RoCE port of the second device, respectively, to form several communication paths.

According to an embodiment of the present disclosure, the step of determining whether the first device is capable of communicating with the second device comprises:
respectively configuring an IP for a first virtual network interface card corresponding to a RoCE port of the first device and a second virtual network interface card corresponding to a RoCE port of the second device;
determining whether a network of the first device can be connected with a network of the second device; and
in response to the network of the first device being able to be connected with the network of the second device, sending information of the first device to the second device, thereby causing the second device to configure according to the information of the first device.

According to an embodiment of the present disclosure, the first device is a host, the second device is a storage node, a RoCE port of the host and a RoCE port of the storage node are connected via an optical fiber, and before respectively configuring an IP for a first virtual network interface card corresponding to a RoCE port of the first device and a second virtual network interface card corresponding to a RoCE port of the second device, the method further comprises:
configuring a BOND port binding through the RoCE port of the host to generate a first virtual network interface card of the host; and
configuring the BOND port binding through the RoCE port of the storage node to generate a second virtual network interface card of the storage node.

According to an embodiment of the present disclosure, the first device is a host and the second device is a storage node, and the step of sending information of the first device to the second device, thereby causing the second device to configure according to the information of the first device comprises:
the storage node using information of the host to configure host management; and
the host discovering the storage node using a first command and connecting to the storage node using a second command to complete a configuration of the host and the storage node.

According to an embodiment of the present disclosure, the storage node using information of the host to configure host management comprises:
the storage node acquiring a unique identification of the host and using the unique identification of the host to configure host management.

According to an embodiment of the present disclosure, the step of the host discovering the storage node using a first command and connecting to the storage node using a second command to complete a configuration of the host and the storage node comprises:
the host discovering the storage node using an NVMe discover command and connecting to the storage nodes using an NVMe connect command, wherein the first command comprises the NVMe discover command and the second command comprises the NVMe connect command.

According to an embodiment of the present disclosure, the first device is a first storage node and the second device is a second storage node, and the step of determining whether the first device is capable of communicating with the second device comprises:
respectively configuring an IP for a first virtual network interface card corresponding to a RoCE port of a first storage node and a second virtual network interface card corresponding to a RoCE port of a second storage node;
determining whether a network of the first storage node is able to connect with a network of the second storage node; and
in response to the network of the first storage node being able to connect with the network of the second storage node, creating a cluster based on the first storage node and the second storage node.

Another aspect of the present application discloses a device for storage system port binding disaster recovery, wherein the device comprises:
a binding module, configured to respectively binding a port of a first device and a port of a second device to form a plurality of communication paths, and calculating a performance of each communication path;
a grouping module, configured to dividing the communication paths into groups based on the performance of the communication paths and performing data transmission based on the groups; and
an adjusting module, configured to, in response to an abnormality in the communication path, adjusting a group-dividing way of the communication paths based on the abnormality cause and a quantity of communication paths in the groups.

Yet another aspect of the present application discloses a computing device, comprising:
at least one processor; and a memory storing thereon computer instructions executable on the processor, wherein the instructions, when executed by the processor, implement the steps of the method above.

Yet another aspect of the present application discloses a non-volatile readable computer storage medium having a computer program stored thereon, wherein the computer program, when executed by a processor, implements the steps of the method above.

The present disclosure has the following beneficial technical effects. The embodiments of the present disclosure provide a method for a storage system port binding disaster recovery, and the technical solution includes the steps: respectively binding a port of first device and a port of second device to form a plurality of communication paths, and calculating the performance of each communication path; grouping the communication paths based on the performance of the communication paths and performing data transmission based on grouping; and in response to an abnormality in the communication path, the packets of the communication paths being adjusted based on the abnormality cause and the quantity of communication paths in each packet. The stability and disaster recovery capability of a communication business can be improved under the scene that multiple paths fail, the standby path can be switched and used to share the business pressure under the scene that the link congestion performance pressure is large, the storage performance can be improved at the port level, and the smoothness and stability of a customer business can be ensured. According to the invention, stable switching of communication paths can be realized, risk forecast reminding is carried out, and the risk of path faults or missing is reduced.

### BRIEF DESCRIPTION OF THE DRAWINGS

In order to explain the technical solutions in embodiments of the present disclosure or the related art more clearly, the following will briefly introduce the drawings needed in the description of the embodiments and the related art. Obviously, the drawings in the following description are merely some embodiments of the present disclosure. For those of ordinary skills in the art, without involving creative efforts, other embodiments can be obtained from these drawings.

FIG. 1 is a schematic flow diagram of a method for port binding disaster recovery according to one embodiment of the present disclosure;

FIG. 2 is a schematic diagram of a host and storage node port binding according to one embodiment of the present disclosure.

FIG. 3 is a schematic diagram of a RoCE-SAN scenario deployment according to one embodiment of the present disclosure;

FIG. 4 is a schematic diagram of a storage node and a storage node port binding according to one embodiment of the present disclosure.

FIG. 5 is a schematic diagram of a RoCE multi-control interconnection scenario deployment according to one embodiment of the present disclosure.

FIG. 6 is a schematic diagram of a communication path grouping according to one embodiment of the present disclosure;

FIG. 7 is a schematic diagram of backup group communication path monitoring according to one embodiment of the present disclosure;

FIG. 8 is a schematic diagram of available group communication path monitoring according to one embodiment of the present disclosure;

FIG. 9 is a schematic diagram of a port binding disaster recovery device according to one embodiment of the present disclosure;

FIG. 10 is a schematic diagram of computer equipment according to one embodiment of the present disclosure; and

FIG. 11 is a schematic diagram of a computer non-volatile readable storage medium according to one embodiment of the present disclosure.

### DETAILED DESCRIPTION OF THE EMBODIMENTS

In order to make the purpose, technical solutions, and advantages of this disclosure clearer, the following is a detailed explanation of embodiments of the present disclosure in conjunction with embodiments and with reference to the accompanying drawings.

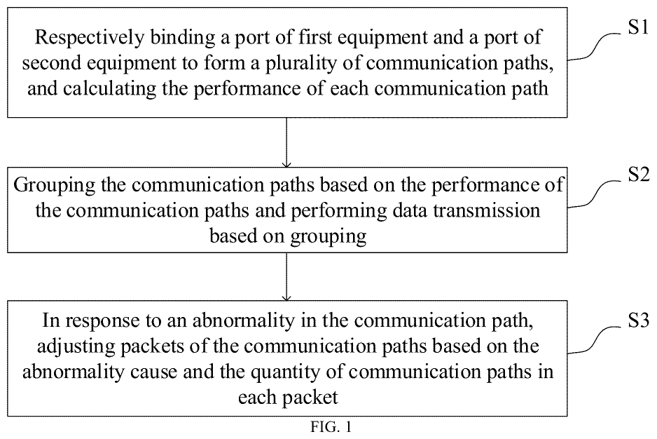

In view of the above object, in a first aspect of embodiments of the present disclosure, one embodiment of a method for storage system port binding disaster recovery is presented. FIG. 1 shows a schematic flow chart of the method.

As shown in FIG. 1, the method may include steps as follows.

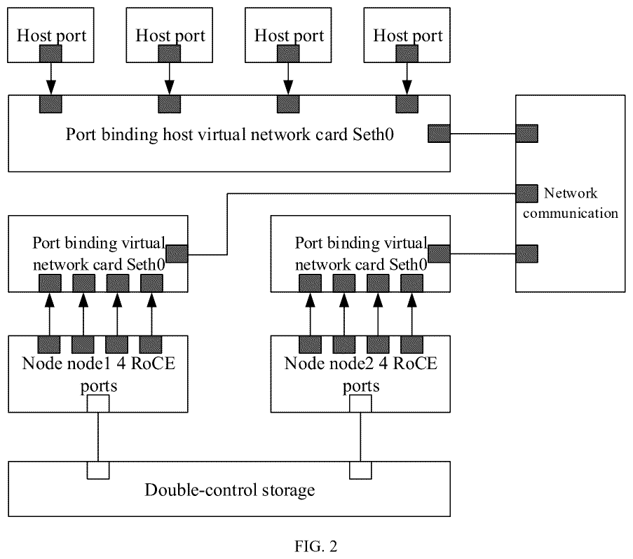

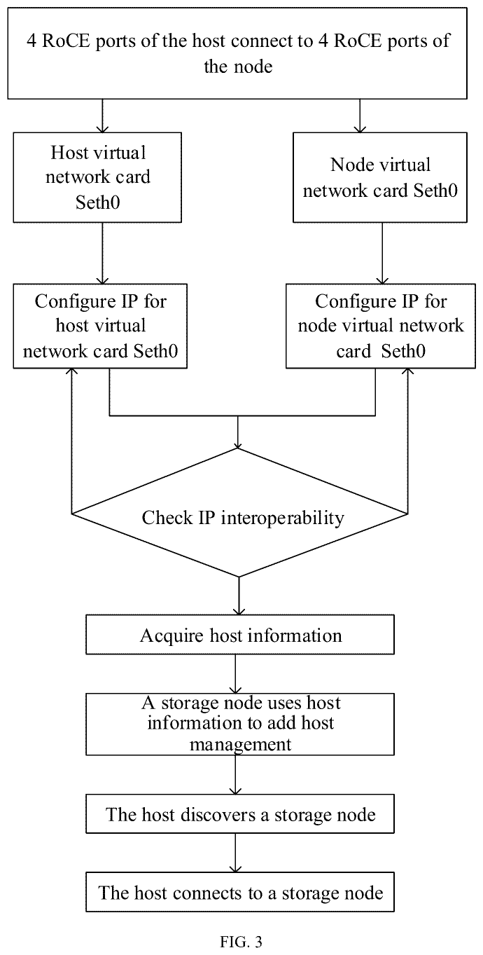

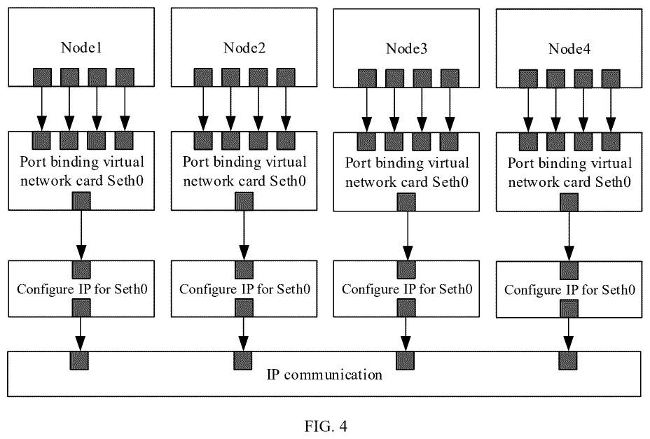

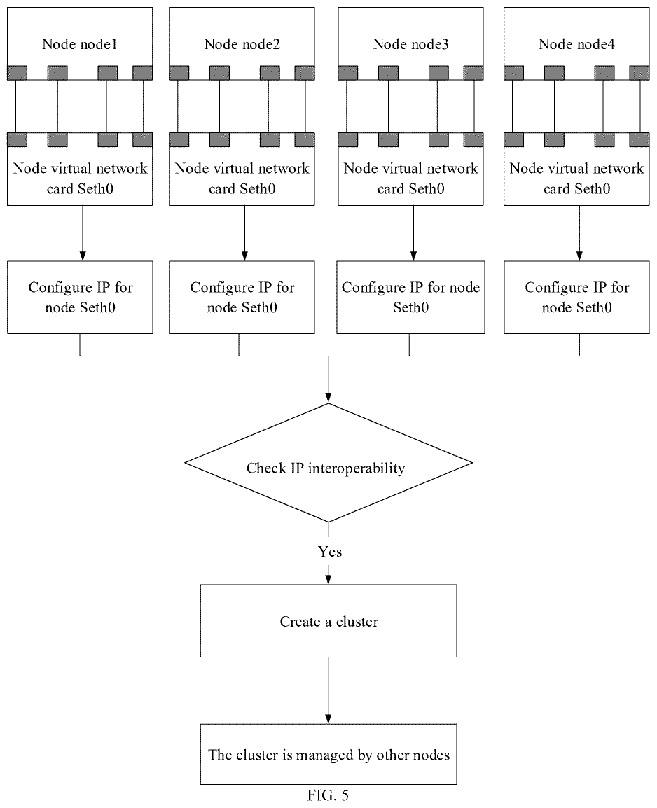

S1, respectively binding a port of a first device and a port of a second device to form a plurality of communication paths, and calculating the performance of each communication path. In one embodiment, in a RoCE-SAN scenario, as shown in FIG. 2, the first device may be a host, and the second device may be a storage node; each RoCE port of the storage node and the host may be connected via an optical fiber line; for example, the scenario that a dual-control storage node1 node has four RoCE ports, and the host has four RoCE ports, then the four RoCE ports of the two equipment are respectively connected to form four communication paths, and then the four RoCE ports of the storage node are selected to configure BOND port binding so as to generate a virtual network interface card Seth0 of the storage node; four RoCE ports of the host are selected to configure BOND port binding so as to generate a virtual network interface card Seth0 of the host, as shown in FIG. 3, in several disclosure scenarios; then an IP is configured for the virtual network interface card Seth0 of the storage node, and an IP is configured for the virtual network interface card Seth0 of the host, and the IPs of the storage node and the host need to be one network segment; the IP of the storage node is PING connected via the host, if the PING connected communication fails, then whether a physical link or the configured IP is correct is checked, and if the PING connection is successful, then a unique identifier of the host is acquired; and the storage node uses the unique identifier of the host to configure host management, and finally the host uses the nvme discover command to discover the storage node and uses the nvme connect command to connect to the storage node, thereby completeing the deployment. In another embodiment, in a RoCE multi-control interconnection scenario, as shown in FIG. 4, the first device may be one storage node, and the second device may be another storage node, for example, the scenario that two storage nodes have a total of four nodes, namely, Node1 to Node4, wherein each node has four RoCE ports; the RoCE ports of the four nodes are connected to the same RoCE switch via optical fiber lines; the four RoCE ports of each node are all configured with BOND port binding so as to generate a virtual network interface card Seth0 of the node; each node's virtual network interface card Seth0 is configured with an IP, and the IPs need to be in the same network segment, as shown in FIG. 5, and then each node needs to perform mutual PING connection between IPs; and if the mutualPING connection between IPs fails, whether the IP configuration or physical link of the virtual network interface card is correct is checked, and if the mutual PING connection between IPs is successful, a cluster is created, and then it is managed by other nodes. In both scenarios, several communication links are formed, and the performance of each communication path needs to be calculated.

S2, dividing the communication paths into groups based on the performance of the communication paths and performing data transmission based on the groups. In several disclosure scenarios, the performance of communication paths can be ranked from high to low, a threshold quantity of communication paths with higher performance ranking is selected as members of an available group for data transmission, and the remaining communication paths are taken as members of a backup group. As shown in FIG. 6, for example, the scenario that the top 50% performance paths are set as members of an active group (available group) and are given an active state to be responsible for I/O transmission work, and the bottom 50% performance paths are set as members of an enabled group (backup group) and are given an enabled state as standby paths. When an abnormity occurs in a communication path of the active group, a communication path in the enabled group can take over the I/O transmission of the abnormal path, which can improve the stability and disaster recovery capability of the communication business in case of multiple path failures, and can switch to use the standby path to share the business pressure in the scenario of large link congestion performance pressure.

S3, in response to an abnormality in the communication path, adjusting a group-dividing way of the communication paths based on the abnormality cause and the quantity of communication paths in thee groups. In several disclosure scenarios, if the abnormity cause of the communication path is path disconnection, a group of the disconnected communication path is determined. If the group of the disconnected communication path is the backup group, the quantity of communication paths of the backup group is acquired. If the quantity of communication paths of the backup group is less than 1, a warning of no redundant path is sent. If the quantity of communication paths of the backup group is equal to 1, the warning of no redundant path is cleared, and a warning of insufficient redundant path is sent, and the disconnected communication path is marked as an unavailable path. If the group of the disconnected communication path is an available group, the quantity of communication paths of the backup group is acquired. If the quantity of communication paths of the backup group is equal to 1, the communication path of the backup group is switched to the available group, and set to an active state, and a warning of no redundant path is sent. If the quantity of communication paths of the backup group is greater than 1, the performance of all the communication paths in the backup group is calculated, the communication path with the highest performance is switched to the available group, and set to the active state, If the quantity of communication paths of the backup group is less than 1, a warning of no redundant path is sent. If the abnormity cause of the communication path is path congestion, the performances of the communication path in which the congestion occurs and of all the communication paths in the backup group are calculated. If the communication path with the highest performance is the communication path in which the congestion occurs, no processing is performed. If the communication path with the highest performance is the communication path in the backup group, the communication path with the highest performance in the backup group is switched to the available group and set to the active state.

By using the technical solution of the invention, the stability and disaster recovery capability of a communication business can be improved under the scene that multiple paths fail, the standby path can be switched and used to share the business pressure under the scene that the link congestion performance pressure is large, the storage performance can be improved at the port level, and the smoothness and stability of a customer business can be ensured. According to the invention, stable switching of communication paths can be realized, risk forecast reminding is carried out, and the risk of path faults or missing is reduced.

In one alternative embodiment of the present disclosure, the step of dividing the communication paths into groups based on the performance of the communication paths and performing data transmission based on the groups includes:
ranking the performances of communication paths from high to low;
selecting a threshold quantity of communication paths with a preceding performance ranking as members of an available group for data transmission; and
taking the remaining communication paths as members of a backup group. After performance ranking, a certain quantity of communication paths can be selected as members of the available group for data transmission. In some embodiments, the top 50% performance paths are set as members of an active group (available group) and are given an active state to be responsible for I/O transmission work, and the bottom 50% performance paths are set as members of an enabled group (backup group) and are given an enabled state as standby paths. When an abnormity occurs in a communication path of the active group, a communication path in the enabled group can take over the I/O transmission of the abnormal path, which can improve the stability and disaster recovery capability of the communication business in case of multiple path failures, and can switch to use the standby path to share the business pressure in the scenario of large link congestion performance pressure.

In one alternative embodiment of the present disclosure, the step of in response to an abnormality in the communication path, adjusting the group-dividing way of the communication paths based on the abnormality cause and the quantity of communication paths in the groups includes:
determining the abnormity cause of the communication path in response to the occurrence of the abnormity of the communication path;
executing a first preset strategy in response to the abnormity cause of the communication path being a path disconnection; and
executing a second preset strategy in response to the abnormity cause of the communication path being path congestion. The abnormity causes of communication paths are usually path disconnection and path congestion. Path disconnection is that the communication path cannot transmit data due to some reasons, and path congestion is that the communication path can transmit data, but the speed of data transmission is slower than the normal speed. In use, the state of each communication link can be detected at every certain time. The present disclosure sets different strategies for the above-mentioned two abnormity causes.

In one alternative embodiment of the present disclosure, the step of executing a first preset strategy in response to the abnormity cause of the communication path being a path disconnection includes:
determining the group of the disconnected communication path in response to the abnormity cause of the communication path being a path disconnection;
in response to the disconnected communication path being grouped into backup group, acquiring the quantity of communication paths of the backup group, and performing a first preset operation based on the acquired quantity; and
in response to the disconnected communication path being grouped into available group, acquiring the quantity of communication paths of the backup group, and performing a second preset operation based on the acquired quantity.

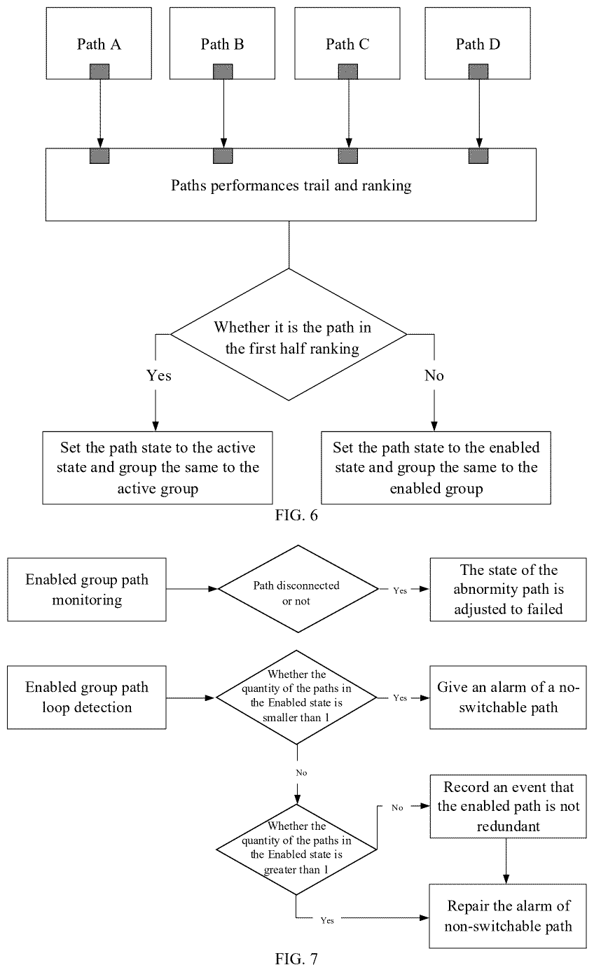

In one alternative embodiment of the present disclosure, as shown in FIG. 7, the step of in response to the disconnected communication path being grouped into a backup group, acquiring the quantity of communication paths of the backup group, and performing a first preset operation based on the acquired quantity includes:
acquiring the quantity of communication paths of the backup group in response to the disconnected communication path being grouped into the backup group;
and in response to the quantity of communication paths of the backup group being less than one, sending a warning of no redundant path. If the abnormity cause of the communication path is path disconnection, and the disconnected communication path is in the backup group, the quantity of communication paths in the current backup group is acquired. If the quantity is less than 1, there is no communication path that can be switched, and a warning of no redundant path is sent.

In one alternative embodiment of the present disclosure, the following step is also included:
in response to the quantity of communication paths of the backup group being equal to 1, clearing the warning of no redundant path, and sending a warning of insufficient redundant paths. If the quantity of communication paths in the backup group is equal to one, it indicates that still one communication path can be switched when needed. If a warning of no redundant path has been sent before, the warning is cleared, and a warning of insufficient redundant paths is sent to notify an administrator to add redundant paths.

In one alternative embodiment of the present disclosure, the following step is also included:
marking the disconnected communication path as an unavailable path. Whether the disconnected communication path is in an available group or in a backup group, it is necessary to mark the disconnected communication path as an unavailable path and send a corresponding warning to notify an administrator to check the condition of the paths.

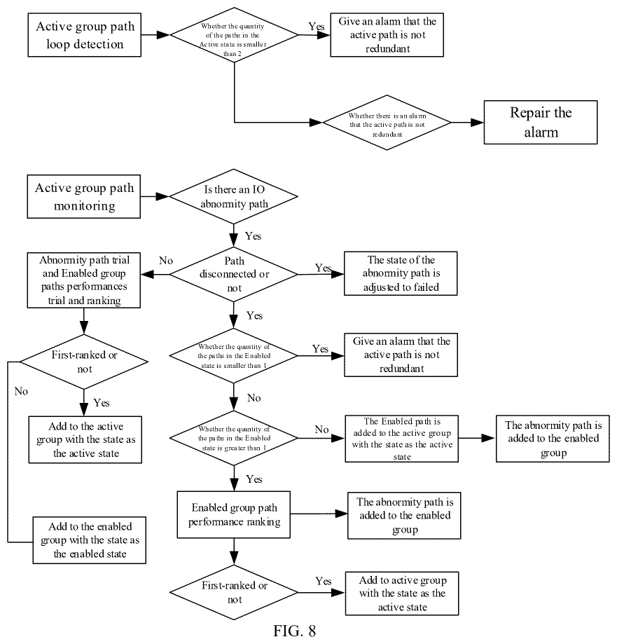

In one alternative embodiment of the present disclosure, as shown in FIG. 8, the step of in response to the disconnected communication path being grouped into available group, acquiring the quantity of communication paths of the backup group, and performing a second preset operation based on the acquired quantity includes:
acquiring the quantity of communication paths of the backup group in response to the disconnected communication path being grouped into the available group;
in response to the quantity of communication paths of the backup group being equal to 1, switching the communication paths of the backup group to the available group and setting the same to active state; and
sending a warning of no redundant path. If the disconnected path is in the available group, the quantity of communication paths in the backup group is first acquired, and if the quantity of communication paths in the backup group is 1, the communication path is switched to the available group and set to an active state to replace the disconnected communication path, and a warning of no redundant path is sent to notify an administrator to add a redundant path.

In one alternative embodiment of the present disclosure, the following steps are also included:
in response to the quantity of communication paths of the backup group being greater than one, calculating performances of all the communication paths in the backup group; and
switching communication path with the highest performance to the available group and setting the same to the active state, If the quantity of communication paths in the backup group is greater than one, the performances of all communication paths in the backup group are recalculated, and then the communication path with the highest performance is switched to the available group and set to the active state to replace the disconnected communication path.

In one alternative embodiment of the present disclosure, the following step is also included:
in response to the quantity of communication paths of the backup group being less than one, sending a warning of no redundant path. If the quantity of communication paths in the backup group is less than one, it indicates that there are no standby communication paths that can be switched, and a warning of no redundant path is sent, The above steps realize the multi-path management of the binding port, monitor the abnormity condition of paths and report the abnormity alarm, and can assist the smooth switching of the paths, so as to realize the warning of the risk forecast, and reduce the risk of the path failure or loss.

In one alternative embodiment of the present disclosure, the step of executing a second preset strategy in response to the abnormity cause of the communication path being path congestion includes:
in response to the abnormity cause of the communication path being path congestion, calculating the performances of the communication path in which congestion occurs and all the communication paths in the backup group;
in response to the communication path with the highest performance being a communication path where congestion occurs, performing no processing; and in response to the communication path with the highest performance being a communication path in the backup group, switching the communication path with the highest performance in the backup group to the available group and setting the same to the active state, If the abnormity cause of the communication path is path congestion, the performances of the communication path in which the congestion occurs and of all the communication paths in the backup group are calculated. If the communication path with the highest performance is the communication path in which the congestion occurs, no processing is performed. If the communication path with the highest performance is the communication path in the backup group, the communication path with the highest performance in the backup group is switched to the available group and set to the active state to replace the disconnected communication path, while the communication path in which congestion occurs is added to the backup group.

In one alternative embodiment of the present disclosure, the step of binding a port of first device with a port of second device to form a communication path includes:
binding a RoCE port of the first device with a RoCE port of the second device to form a communication path;
respectively creating a virtual network interface card of the RoCE port of the first device and a virtual network interface card of the RoCE port of the second device; and determining whether the first device is capable of communicating with the second device,

In one alternative embodiment of the present disclosure, the step of binding a RoCE port of first device with a RoCE port of second device to form a communication path includes:
creating a one-to-one connection between each RoCE port of the first device and each RoCE port of the second device, respectively, to form several communication paths. For example, the scenario that a first port of the first device is connected to a first port of the second device, a second port of the first device is connected to a second port of the second device, and so on.

In one alternative embodiment of the present disclosure, the step of determining whether the first device is capable of communicating with the second device includes:
respectively configuring an IP for a first virtual network interface card corresponding to a RoCE port of the first device and a second virtual network interface card corresponding to a RoCE port of the second device;
PING connecting the IP of the second device via the first device; and
in response to the first device being capable of successfully PING connecting with the IP of the second device, sending the information of the first device to the second device, thereby causing the second device to configure according to the information of the first device, The IDs configured for the virtual network interface card need to be in the same network segment. If PING connection fails, it needs to check whether the physical link or the configured IP is correct.

In one alternative embodiment of the present disclosure, the first device includes a host and the second device includes a storage node.

In one alternative embodiment of the present disclosure, the step of sending the information of the first device to the second device, thereby causing the second device to configure according to the information of the first device includes:
the storage node using the information about the host to configure host management; and
the host discovering the storage node using a first command and connecting to the storage node using a second command to complete the configuration of the host and the storage node. In one embodiment, in a RoCE-SAN scenario, the first device may be a host, and the second device may be a storage node; each RoCE port of the storage node and the host may be connected via an optical fiber line; for example, the scenario that a dual-control storage node1 node has four RoCE ports, and the host has four ROCE ports, then the four ROCE ports of the two equipment are respectively connected to form four communication paths, and then the four RoCE ports of the storage node are selected to configure BOND port binding so as to generate a virtual network interface card Seth0 of the storage node; four RoCE ports of the host are selected to configure BOND port binding so as to generate a virtual network interface card Seth1 of the host; then an IP is configured for the virtual network interface card Seth0 of the storage node, and an IP is configured for the virtual network interface card Seth1 of the host, and the IPs of the storage node and the host need to be one network segment; the IP of the storage node is PING connected via the host, if the PING connection fails, then whether a physical link or the configured IP is correct is checked, and if the PING connection is successful, then a unique identifier of the host is acquired; and the storage node uses the unique identifier of the host to configure host management, and finally the host uses the nvme discover command to discover the storage node and uses the nvme connect command to connect to the storage node, thereby completeing the deployment.

In one alternative embodiment of the present disclosure, the first device is a first storage node and the second device is a second storage node.

In one alternative embodiment of the present disclosure, the step of determining whether the first device is capable of communicating with the second device includes:
respectively configuring an IP for a first virtual network interface card corresponding to a RoCE port of a first storage node and a second virtual network interface card corresponding to a RoCE port of a second storage node;
PING connecting an IP of a second storage node via a first storage node; and
in response to the first storage node being capable of succesfully PING connected with the second storage node's IP, creating a cluster based on the first storage node and the second storage node. In another embodiment, in a RoCE multi-control interconnection scenario, the first device may be one storage node, and the second device may be another storage node, for example, the scenario that two storage nodes have a total of four nodes, namely, Node1 to Node4, wherein each node has four RoCE ports; the RoCE ports of the four nodes are connected to the same RoCE switch via optical fiber lines; the four RoCE ports of each node are all configured with BOND port binding so as to generate a virtual network interface card Seth0 of the node; each node's virtual network interface card Seth0 is configured with an IP, and the IPs need to be in the same network segment, and then each node needs to perform mutual PING connection; and if the PING connection fails at the IP, whether the IP configuration or physical link of the virtual network interface card is correct is checked, and if the PING connection is successful at the IP, a cluster is created, and then it is managed by other nodes. In both scenarios, several communication links are formed, and the performance of each communication path needs to be calculated.

In other embodiments, the first device may be multiple hosts, the second device may be multiple storage nodes, the first device may be multiple storage nodes, and the second device may also be multiple storage nodes, i.e. the quantity of equipment in the first device and the second device is not limited.

The present disclosure realizes a port binding mode based on a RoCE network port, merges four or more ports into one virtual network interface, designs multi-path management, provides high-performance and high-stability service to the outside world, and has the following effects.
Effect 1: with the RoCE-SAN business based on port binding, the paths of active group and enabled group are mutually backed up such that in case of multiple path failures the backup path can take over, thereby improving the stability and disaster recovery capability of RoCE-SAN business.
Effect 2: with the RoCE-SAN business based on port binding, active group and enabled group paths achieve load balancing. In the scenario of large performance pressure of link congestion, switching to use an enabled path to share business pressure is performed, improving the performance of storage at the port level by at least two times, and ensuring the fluency and stability of customer business.
Effect 3: they realize the multi-path management of the binding port, monitor the abnormity condition of paths and report the abnormity alarm, and can assist the smooth switching of the paths, so as to realize the warning of the risk forecast, and reduce the risk of the path failure or loss.
Effect 4: RoCE cluster interconnection based on port binding can virtualize multiple physical ports into a logical port, and the path specification of cluster interconnection no longer depends on the software specification, which can achieve four times, eight times or even more of the original cluster path expansion, with no theoretical upper limit.

It should be noted that one of ordinary skill in the art would understand that implementing all or part of the flow of the methods of the embodiments described above may be accomplished by a computer program that instructs associated hardware, and that the program may be stored on a computer non-volatile readable storage medium, and that when the program is executed, it may include the flow of the embodiments of the methods as described above. The non-volatile readable storage medium may be a magnetic disk, an optical disk, read-only memory (ROM), random access memory (RAM), or the like. Embodiments of the computer program described above may achieve the same or similar effects as any of the method embodiments described above to which they correspond.

In addition, the methods disclosed according to the embodiments of the present disclosure may also be implemented as a computer program executed by a CPU, and the computer program may be stored in a computer non-volatile readable storage medium. The computer program, when executed by a CPU, performs the above-described functions as defined in the methods disclosed in the embodiments of the present disclosure.

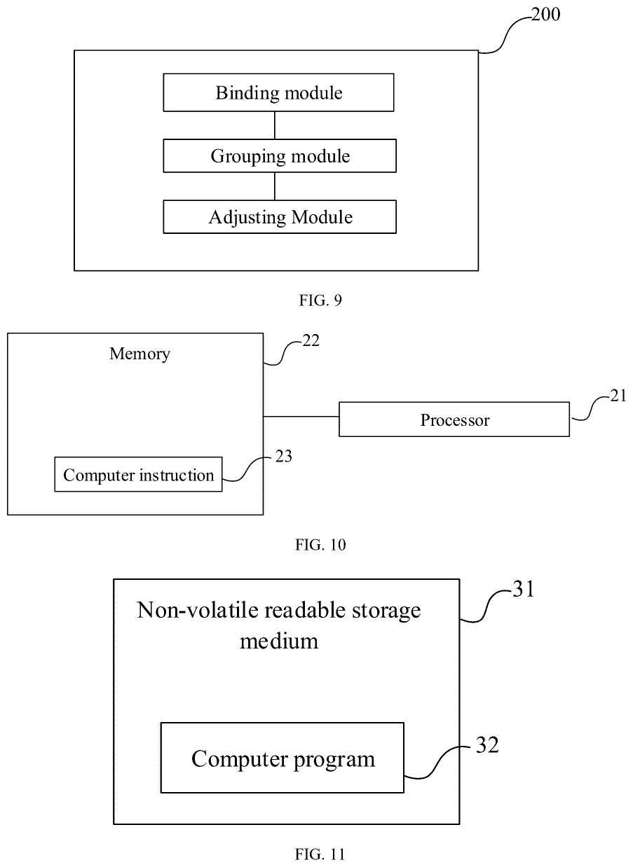

Based on the above-mentioned object, in a second aspect of the embodiments of the present disclosure, a device for port binding disaster recovery is proposed, and as shown in FIG. 9, the device 200 includes:
a binding module configured for respectively binding a port of first device and a port of second device to form a plurality of communication paths, and calculating the performance of each communication path;
a grouping module configured for grouping the communication paths based on the performance of the communication paths and performing data transmission based on grouping; and
an adjustment module configured for, in response to an abnormality in the communication path, adjusting the packets of the communication paths based on the abnormality cause and the quantity of communication paths in each packet.

In view of the above object, in a third aspect of the embodiments of the present disclosure, computer equipment is proposed. FIG. 10 is a schematic diagram of an embodiment of computer equipment as provided herein. As shown in FIG. 10, the embodiment of the present disclosure includes the following devices: at least one processor 21; and a memory 22 storing a computer instruction 23 executable on the processor, wherein the instruction, when executed by the processor, implements any one of the above methods.

In view of the above object, in a fourth aspect of the embodiments of the present disclosure, a computer non-volatile readable storage medium is proposed. FIG. 11 is a schematic diagram of an embodiment of a computer non-volatile readable storage medium provided herein. As shown in FIG. 11, a computer non-volatile readable storage medium 31 stores a computer program 32 which, when executed by a processor, executes any one of the above methods.

In addition, the methods disclosed according to the embodiments of the present disclosure may also be implemented as a computer program executed by a processor, and the computer program may be stored in a computer non-volatile readable storage medium. The computer program, when executed by a processor, performs the above-described functions as defined in the methods disclosed in the embodiments of the present disclosure.

In addition, the above method steps and system units can also be implemented by using a controller, and a computer non-volatile readable storage medium for storing computer programs that enable the controller to implement the functions of the above steps or units.

Technicians in this field will also understand that various exemplary logical blocks, modules, circuits, and algorithm steps described herein can be implemented as electronic hardware, computer software, or a combination of both. To clearly illustrate this interchangeability of hardware and software, various illustrative components, blocks, modules, circuits, and steps have been described above generally in terms of their functionality. Whether such functionality is implemented as software or hardware depends upon the disclosure and design constraints imposed on the overall system. Skilled artisans may implement the described functionality in varying ways for each disclosure, but such implementation decisions should not be interpreted as causing a departure from the scope of the disclosed embodiments.

In one or more exemplary designs, the functions may be implemented in hardware, software, firmware, or any combination thereof. If implemented in software, the functions may be, as one or more instructions or codes, stored on or transmitted over a computer non-volatile readable storage medium. Computer non-volatile readable storage medium includes computer storage medium and communication medium. The communication medium includes any non-volatile readable storage medium that facilitates the transfer of a computer program from one place to another. The storage medium may be any available non-volatile readable storage medium that can be accessed by a general purpose or special purpose computer. By way of example, and not limitation, such computer non-volatile readable storage medium can include RAM, ROM, EEPROM (Electrically Erasable Programmable Read-Only Memory), CD-ROM (Compact Disc-Read Only Memory) or other optical disk storage equipment, magnetic disk storage equipment or other magnetic storage equipment, or any other non-volatile readable storage medium that can be configured to carry or store desired program code in the form of instructions or data structures and that can be accessed by a general-purpose or special-purpose computer, or a general-purpose or special-purpose processor. In addition, any connection is properly termed a computer non-volatile readable storage medium. For example, the scenarion that if coaxial cables, fiber optic cables, twisted pair cables, digital subscriber lines (DSL), or wireless technologies such as infrared, radio, and microwave are used to send software from websites, servers, or other remote sources, then the aforementioned coaxial cables, fiber optic cables, twisted pair cables, DSL, or wireless technologies such as infrared, radio, and microwave are all included in the definition of non-volatile readable storage media. As used herein, magnetic and optical disks include Compact Disc (CD), laser disc, optical disc, Digital Versatile Disc (DVD), floppy disk, and Blu ray disc, wherein magnetic disks typically reproduce data magnetically, while optical discs reproduce data optically using lasers. Combinations of the above should also be included within the scope of the computer non-volatile readable storage medium.

The foregoing are exemplary embodiments of the present disclosure, but it should be noted that various changes and modifications could be made herein without departing from the scope disclosed in the embodiments of the present disclosure as defined by the appended claims. The functions, steps, and/or actions of the method claims according to the disclosed embodiments described herein need not be performed in any particular order. Furthermore, although elements disclosed in the embodiments may be described or claimed in the singular, the plural can be contemplated unless limitation to the singular is explicitly stated.

It should be understood that, unless the context clearly supports an exception, the singular form “one” is intended to include the plural form as well herein. It should also be understood that the use of “and/or” herein is meant to include any and all possible combinations of one or more of the associated listed items.

The above-disclosed embodiment numbers in this disclosure are for descriptive purposes only and do not represent the advantages or disadvantages of the embodiments.

It could be understood by those of ordinary skill in the art that all or a portion of the steps for implementing the embodiments described above may be performed by hardware, or may be performed by a program that instructs the associated hardware. The program may be stored in a computer non-volatile readable storage medium, such as read-only memory, magnetic disk or optical disk.

It should be understood by those of ordinary skill in the art that the discussion of any embodiment above is intended to be merely exemplary, and is not intended to suggest that the scope of the disclosure of the embodiments of the present disclosure (including the claims) is limited to these examples; and combinations of technical features in the above embodiments or in different embodiments are also possible within the framework of embodiments of the present disclosure, and many other variations of different aspects of the embodiments of the present disclosure as described above are present and are not provided in detail for the sake of brevity. Therefore, any omission, modification, equivalent substitution, improvement, etc. made within the spirit and principles of the embodiments of this disclosure should be included in the scope of protection of the embodiments of this disclosure.

1. A method for storage system port binding disaster recovery, comprising:
respectively binding a port of a first device and a port of a second device to form a plurality of communication paths, and calculating a performance of each communication path;
dividing the communication paths into groups based on the performance of the communication paths and performing data transmission based on the groups; and
in response to an abnormality in the communication path, adjusting a group-dividing way of the communication paths based on the abnormality cause and a quantity of communication paths in the groups;
wherein the step of binding a port of a first device and a port of a second device to form a communication path comprises:
binding a RoCE port of the first device with a RoCE port of the second device to form a communication path;
respectively creating a virtual network interface card of the RoCE port of the first device and a virtual network interface card of the RoCE port of the second device; and
determining whether the first device is capable of communicating with the second device.

2. The method according to claim 1, wherein the step of dividing the communication paths into groups based on the performance of the communication paths and performing data transmission based on the groups comprises:
ranking the performances of communication paths from high to low;
selecting a threshold quantity of communication paths with a preceding performance ranking as members of an available group for data transmission; and
taking remaining communication paths as members of a backup group.

3. The method according to claim 2, wherein,
selecting a threshold quantity of communication paths with a preceding performance ranking as members of an available group for data transmission comprises:
determining the communication paths with a first 50% of the performance ranking as members of the available group;
taking remaining communication paths as members of a backup group comprises:
determining the communication paths with a last 50% of the performance ranking as members of the backup group.

4. The method according to claim 3, wherein
determining the communication paths with a first 50% of the performance ranking as members of the available group comprises:
setting the communication paths with the first 50% of the performance ranking as members of an active state, wherein the communication paths in the active state are used for data transmission;
and determining the communication paths with a last 50% of the performance ranking as members of the backup group comprises:
setting the communication paths with the last 50% of the performance ranking to an enabled state, wherein the communication paths in the enabled state are used for taking over abnormal communication paths in the available group for data transmission when an abnormity occurs to the communication paths in the available group.

5. The method according to claim 2, wherein the step of in response to an abnormality in the communication path, adjusting a group-dividing way of the communication paths based on the abnormality cause and a quantity of communication paths in the groups comprises:
determining the abnormity cause of the communication path in response to an occurrence of an abnormity of the communication path;
executing a first preset strategy in response to the abnormity cause of the communication path being a path disconnection; and
executing a second preset strategy in response to the abnormity cause of the communication path being path congestion.

6. The method according to claim 5, wherein the step of executing a first preset strategy in response to the abnormity cause of the communication path being a path disconnection comprises:
in response to the abnormity cause of the communication path being path disconnection, marking a disconnected communication path as an unavailable path, and determining a group-dividing way of the disconnected communication path;
in response to the disconnected communication path being grouped into the backup group, acquiring the quantity of communication paths of the backup group, and performing a first preset operation based on an acquired quantity; and
in response to the disconnected communication path being grouped into the available group, acquiring the quantity of communication paths of the backup group, and performing a second preset operation based on an acquired quantity.

7. The method according to claim 6, wherein the step of in response to the disconnected communication path being grouped into the backup group, acquiring the quantity of communication paths of the backup group, and performing a first preset operation based on the acquired quantity comprises:
acquiring the quantity of communication paths of the backup group in response to the disconnected communication path being grouped into the backup group;
in response to the quantity of communication paths of the backup group being less than 1, sending a warning of no redundant path; and
in response to the quantity of communication paths of the backup group being equal to 1, clearing the warning of no redundant path, and sending a warning of insufficient redundant paths.

8. The method according to claim 6, wherein the step of in response to the disconnected communication path being grouped into the available group, acquiring the quantity of communication paths of the backup group, and performing a second preset operation based on an acquired quantity comprises:
acquiring the quantity of communication paths of the backup group in response to the disconnected communication path being grouped into the available group;
in response to the quantity of communication paths of the backup group being equal to 1, switching the communication paths of the backup group to the available group and setting the same to active state and sending a warning of no redundant path;
in response to the quantity of communication paths of the backup group being greater than 1, calculating performances of all the communication paths in the backup group;
switching communication path with a highest performance to the available group and setting the same to the active state; and
in response to the quantity of communication paths of the backup group being less than 1, sending a warning of no redundant path.

9. The method according to claim 5, wherein the step of executing a second preset strategy in response to the abnormity cause of the communication path being path congestion comprises:
in response to the abnormity cause of the communication path being path congestion, calculating the performances of the communication path in which congestion occurs and all communication paths in the backup group;
in response to the communication path with a highest performance being a communication path where congestion occurs, taking no action; and
in response to the communication path with the highest performance being a communication path in the backup group, switching the communication path with the highest performance in the backup group to the available group and setting the same to the active state.

10. (canceled)

11. The method according to claim 1, wherein the step of binding a RoCE port of the first device with a RoCE port of the second device to form a communication path comprises:
creating a one-to-one connection between each RoCE port of the first device and each RoCE port of the second device, respectively, to form several communication paths.

12. The method according to claim 1, wherein the step of determining whether the first device is capable of communicating with the second device comprises:
respectively configuring an IP for a first virtual network interface card corresponding to a RoCE port of the first device and a second virtual network interface card corresponding to a RoCE port of the second device;
determining whether a network of the first device can be connected with a network of the second device; and
in response to the network of the first device being able to be connected with the network of the second device, sending information of the first device to the second device, thereby causing the second device to configure according to the information of the first device.

13. The method according to claim 12, wherein the first device is a host, the second device is a storage node, a RoCE port of the host and a RoCE port of the storage node are connected via an optical fiber, and before respectively configuring an IP for a first virtual network interface card corresponding to a RoCE port of the first device and a second virtual network interface card corresponding to a RoCE port of the second device, the method further comprises:
configuring a BOND port binding through the RoCE port of the host to generate a first virtual network interface card of the host; and
configuring the BOND port binding through the RoCE port of the storage node to generate a second virtual network interface card of the storage node.

14. The method according to claim 12, wherein the first device is a host and the second device is a storage node, and the step of sending information of the first device to the second device, thereby causing the second device to configure according to the information of the first device comprises:
the storage node using information of the host to configure host management; and
the host discovering the storage node using a first command and connecting to the storage node using a second command to complete a configuration of the host and the storage node.

15. The method according to claim 14, wherein the storage node using information of the host to configure host management comprises:
the storage node acquiring a unique identification of the host and using the unique identification of the host to configure host management.

16. The method according to claim 14, wherein the step of the host discovering the storage node using a first command and connecting to the storage node using a second command to complete a configuration of the host and the storage node comprises:
the host discovering the storage node using an NVMe discover command and connecting to the storage nodes using an NVMe connect command, wherein the first command comprises the NVMe discover command and the second command comprises the NVMe connect command.

17. The method according to claim 1, wherein the first device is a first storage node and the second device is a second storage node, and the step of determining whether the first device is capable of communicating with the second device comprises:
respectively configuring an IP for a first virtual network interface card corresponding to a RoCE port of a first storage node and a second virtual network interface card corresponding to a RoCE port of a second storage node;
determining whether a network of the first storage node is able to connect with a network of the second storage node; and
in response to the network of the first storage node being able to connect with the network of the second storage node, creating a cluster based on the first storage node and the second storage node.

18. (canceled)

19. A computing device, comprising:
at least one processor; and
a memory storing thereon computer instructions executable on the processor, wherein the instructions, when executed by the processor, implement the steps of the method according to claim 1.

20. A non-volatile readable computer storage medium having a computer program stored thereon, wherein the computer program, when executed by a processor, implements the steps of the method according to claim 1.

21. The method according to claim 9,
wherein the step of in response to the communication path with the highest performance being a communication path in the backup group, switching the communication path with the highest performance in the backup group to the available group and setting the same to the active state comprises:
in response to the communication path with the highest performance being a communication path in the backup group, switching the communication path with the highest performance in the backup group to the available group and setting the same to the active state, and adding the communication path in which congestion occurs to the backup group.
